(19) United States
(12) Patent Application Publication
(10) Pub. No.: US 2021/0339681 A1
(43) Pub. Date: Nov. 4, 2021

(54) ACCESS LADDER FOR A WORK VEHICLE

(71) Applicant: AGCO Corporation, Duluth, GA (US)

(72) Inventors: Nicole Ruth McNEA, Jackson, MN (US); Petrus Henricus Johannes Bouten, Jackson, MN (US)

(21) Appl. No.: 17/244,959

(22) Filed: Apr. 30, 2021

Related U.S. Application Data
(60) Provisional application No. 63/017,985, filed on Apr. 30, 2020.

(51) Int. Cl. B60R 3/02

(52) U.S. Cl. CPC B60R 3/02; A01C 23/008

(57) ABSTRACT

An access ladder includes an upper ladder portion having an upper step. A lower ladder portion is pivotally connected to a lower end of the upper ladder portion for movement around an axis that is parallel to the upper step. The lower ladder portion has a lower step having an orientation with respect to the upper step that is maintained when the lower ladder portion is pivoted with respect to the upper ladder portion.

### CROSS-REFERENCE TO RELATED APPLICATION

The present application claims the benefit of and priority from U.S. Provisional Patent Application 63/017,985, filed Apr. 30, 2020, the entire disclosure of which is hereby incorporated by reference.

### FIELD

This disclosure relates to access ladders for work vehicles and particularly, but not exclusively so, to access ladders suitable for work vehicles which have variable or adjustable ground clearance.

### BACKGROUND

Work vehicles, for example in the field of agriculture, construction, and forestry, typically operate in environments with uneven terrain. Some work vehicles, such as crop sprayers for example, are provided with variable height suspension to allow adjustment of the ground clearance above growing crops. Moreover, the ground clearance of a work vehicle can vary depending on terrain, the tire size, tire inflation, and vehicle payload, for example.

Access ladders are typically provided to give easy access for operators to operating or inspection platforms or to a cab, the ladders being mounted to the chassis. The maximum height of the lowest or first step of an access ladder from the ground is controlled in some countries by regulation, for example by ISO standards ISO 4254-1:2013, ISO 2867:2011, and ISO 26322-1:2008. The variation in ground clearance associated with work vehicles as described above can present problems with meeting the requirements of these regulations and also with maintaining a consistent height of the first step. Moreover, insufficient ground clearance can cause the first step to contact the ground.

Some access ladders are pivotally attached with respect to the chassis to allow them to be stowed when not required or to pivot when coming into contact with the ground. U.S. Pat. No. 9,994,159, “Multi-Position Stair Assembly for Work Vehicles,” granted Jun. 12, 2018, discloses a multi-position stair assembly fora work vehicle, the contents of which is incorporated herein by reference. The stair assembly disclosed in U.S. Pat. No. 9,994,159 has a stepped support that is moved between a retracted orientation and an extended orientation. In the retracted orientation, the first step is disposed at a greater height above the ground than when in the extended orientation.

Pivoting of an access ladder, or a portion of the ladder, away from an operable position causes the angle of the steps to change. The change in the angle of the steps presents a risk of slipping or tripping when a user attempts to use the ladder through either ascending or descending. This risk could result in injury of the user.

### BRIEF SUMMARY

An access ladder for a work vehicle includes an upper ladder portion for attachment to a vehicle chassis and comprising an upper step, and a lower ladder portion pivotally connected to a lower end of the upper ladder portion for movement around an axis that is parallel to the upper step and comprising a lower step having an orientation with respect to the upper step that is maintained when the lower ladder portion is pivoted with respect to the upper ladder portion. By maintaining the orientation of the lower step with respect to the upper step even when the lower ladder portion is pivoted, the lower step may be kept at a consistent angle, which can reduce the risk of slipping or tripping.

In one embodiment, the lower step is coupled to the upper ladder portion by a four-bar linkage. The four-bar linkage may include two pairs of grounded links connected to opposite sides of the lower step. The four-bar linkage may be configured to maintain the orientation of the lower step with respect to the upper step as the lower ladder portion is pivoted.

In one embodiment, the lower ladder portion has a pair of lower side rails between which the lower step is pivotally attached, the lower side rails being pivotally connected to the lower end of the upper ladder portion. A connecting link is pivotally connected at an upper end to the upper ladder portion and at a lower end to the lower step. The connecting link may be connected to the upper step through a slot formed in one of the lower side rails. The connecting link may be connected to the lower step through a slot formed in one of the lower side rails.

The access ladder may have biasing means adapted to bias the lower ladder portion into alignment with the upper ladder portion to urge the steps of the upper and lower ladder portions to form a continuous, aligned, flight of steps if the lower portion has the necessary ground clearance. The biasing means may be a gas spring connected between the upper ladder portion and the lower ladder portion. Alternative biasing means including coil springs and the like may also be used.

In another embodiment the upper step and the lower step are flat steps having a major foot engagement surface and a tread depth dimension that is greater than a step height dimension. The flat steps of both the upper and lower ladder portions may be oriented horizontally for a preferred ergonomic engagement even when the lower ladder portion is pivoted with respect to the upper ladder portion.

The access ladder may be embodied in a range of different work vehicles and offers particular benefits to those that operate in conditions that result in variable ground clearance. In one embodiment, an agricultural crop sprayer has wheels supporting a chassis with variable height suspension to provide variable ground clearance, and the access ladder is secured to the chassis. The lower ladder portion contacts the ground when the variable height suspension is set to a lowest ground clearance.

### BRIEF DESCRIPTION OF THE DRAWINGS

Further advantages will become apparent from reading the following description of specific embodiments with reference to the appended drawings, in which:

FIG. 1A is a front view of an agricultural crop sprayer with an access ladder;

FIG. 1B is a side view of the access ladder of FIG. 1A;

FIG. 1C is a perspective view of the access ladder of FIG. 1A shown with the lower ladder portion in an aligned position;

FIG. 1D is a perspective view of the lower ladder portion of FIG. 1C;

FIG. 1E is a perspective view of the access ladder of FIG. 1A shown with the lower ladder portion in a pivoted position;

FIG. 1F is a side elevation view of the access ladder of FIG. 1E shown with the lower ladder portion in a pivoted position;

FIGS. 2A-D show various views of another access ladder;

FIGS. 3A-D show various views of another access ladder;

FIGS. 4A-D show various views of another access ladder; and

FIGS. 5A-D show various views of yet another access ladder.

### DETAILED DESCRIPTION

While the disclosure will be described in connection with these drawings, there is no intent to limit to the embodiment or embodiments disclosed herein. Although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications, and equivalents included within the scope of the disclosure as defined by the appended claims. Further, it should be appreciated in the context of the present disclosure that the claims are not necessarily limited to the particular embodiments set out in the description.

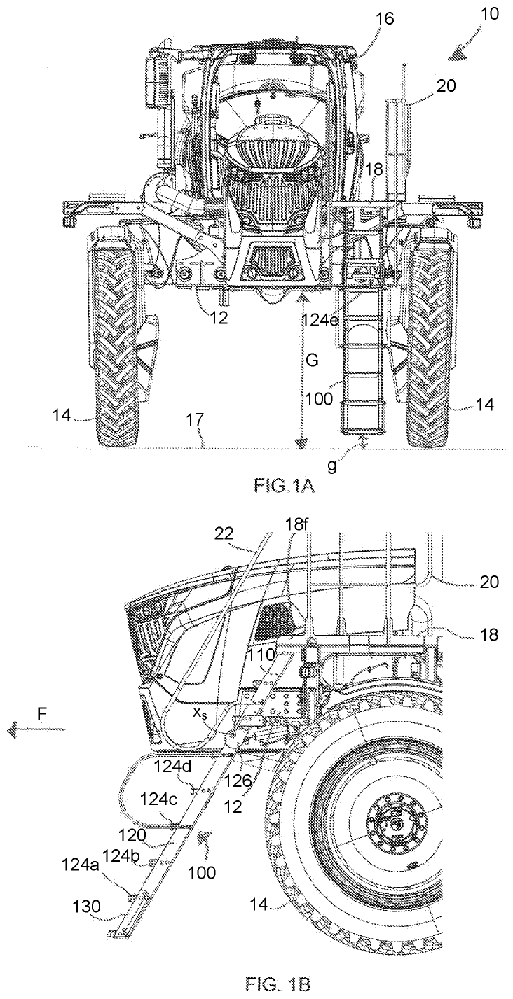

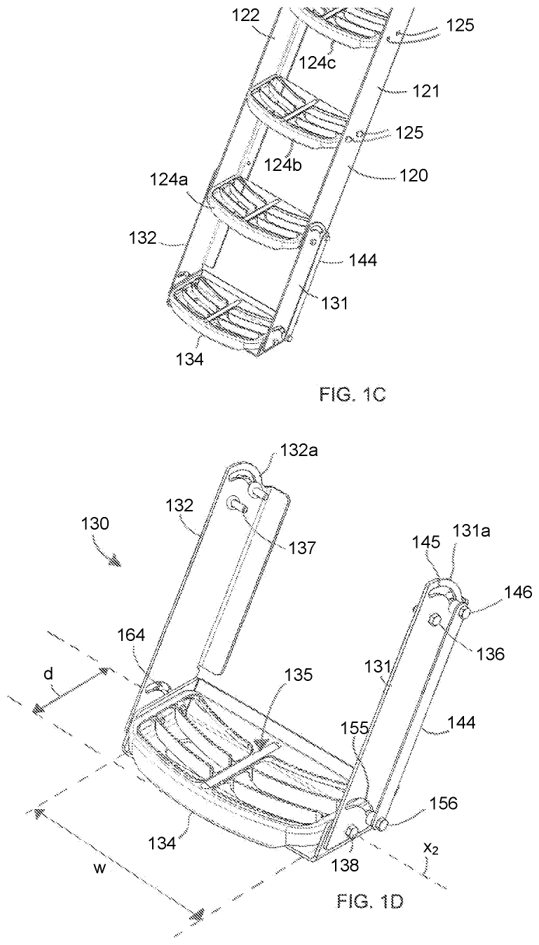

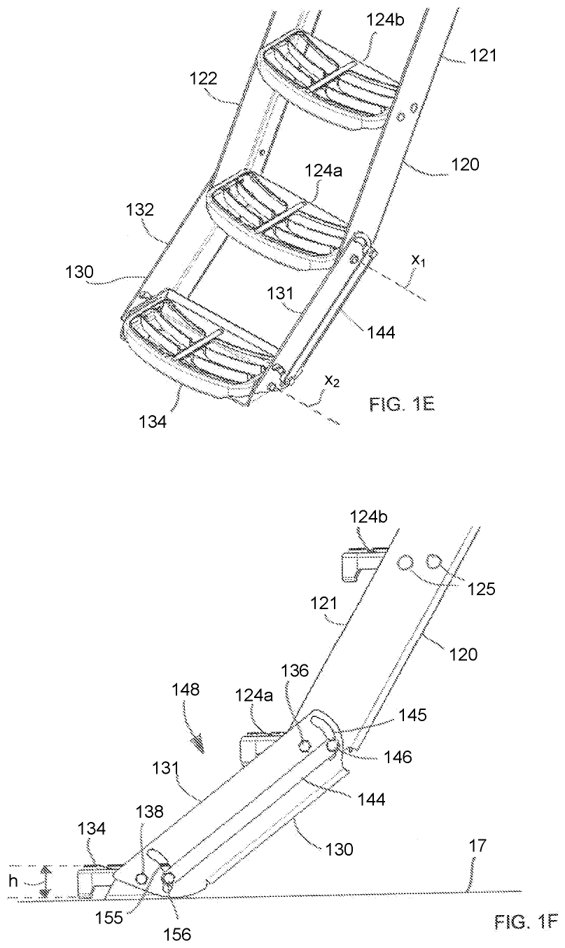

With reference to FIGS. 1A-F, an agricultural crop sprayer 10 has a chassis 12 and ground-engaging wheels 14 mounted to the chassis by variable height suspension such as that disclosed by U.S. Pat. No. 9,079,470, “Vehicle with Chassis Height Adjustment,” granted Jul. 14, 2015, the contents of which is incorporated herein by reference. The variable height suspension allows the ground clearance ‘G’ of the sprayer 10 to be controlled from the operator's cab 16. In one embodiment, the ground clearance ‘G’ is measured as the distance from an underside of the chassis 12 to the ground surface 17. In a low-ground-clearance configuration, for example, the chassis 12 is raised with respect to the wheels 14. In a high-ground-clearance configuration, the chassis 12 is lowered with respect to the wheels 14.

References made hereinafter to relative terms such as front, rear, side, transverse, and longitudinal are made with reference to a normal forward direction of travel of the sprayer 10 as indicated by arrow F in FIG. 1B, wherein the longitudinal direction is parallel to the forward direction F.

An access ladder 100 is secured to the chassis 12. In the illustrated embodiment, the ladder 100 is secured to an operator's platform 18, which has a guard rail 20 and serves as an access platform to the cab 16. The platform 18 is fixed to the chassis 12 and therefore rises and falls with respect to the ground surface 17 as the variable height suspension is adjusted.

Although the access ladder 100 is shown fitted to an agricultural crop sprayer 10, the ladder 100 may be fitted to a range of alternative work vehicles in the fields of agriculture, construction, and forestry, by way of example. In the field of agriculture, the ladder may be fitted to a combine, a tractor, or towed implements including trailed sprayers, planters, and seeders, for example.

Best shown in FIG. 1B, the ladder 100 comprises a fixed ladder portion 110, an upper ladder portion 120, and a lower ladder portion 130. The fixed ladder portion 110 is fixed along a front edge 18f of the platform 18 and provides a flight of one or more steps (two in the illustrated example) and descends forwardly from the platform 18. Two spaced-apart side plates bolted to the front edge of platform 18 support the two steps. The fixed ladder portion 110 is provided with a handrail 22 that is secured to handrail 20 and serves to assist a user descending or ascending the ladder 100.

The upper ladder portion 120 comprises first and second upper side rails 121, 122, which may be formed of steel or aluminum plate. The upper side rails 121, 122 are held apart in a parallel spaced relationship by one or more upper steps (five in the illustrated example). The five upper steps 124a-e are each bolted to the upper side rails 121, 122 by a pair of bolts 125 at each end. Each bolt 125 in a respective pair is spaced apart to ensure no movement between the steps 124 and the upper side rails 121, 122.

The upper side rails 121, 122 are each pivotably mounted to the lower end of the respective side rails of fixed ladder portion 110 by a pivoting joint 126. The upper ladder portion 120 is thus hinged around a transverse ‘stow’ axis xₛ, which passes through the pivoting joints 126. The upper ladder portion 120 is pivotable between an operating position (as shown in FIGS. 1A and 1B) and a stowed position in which the upper ladder portion 120 is swung forwardly and upwardly for transport, for example. In one embodiment, the pivotable joints 126 may each have a stop mechanism to maintain the upper ladder portion 120 in alignment with the fixed ladder portion 110 when in the operating position as shown in FIGS. 1A and 1B. When the upper ladder portion 120 is in the operating position, the steps 124a-e are spaced apart with a regular rise to offer ergonomic comfort for a user. Furthermore, the steps 124a-e are positioned on the upper side rails 121, 122 to present a regularly-spaced continuous flight of steps together with the steps of the fixed ladder portion 110.

With reference to FIG. 1D, the lower ladder portion 130 comprises first and second lower side rails 131, 132 which may be formed of steel or aluminum plate, for example. The first lower side rail 131 is pivotably mounted at an upper end 131a to a lower end of the first upper side rail 121 by a pivot connection which is provided in the illustrated embodiment by a bolt fastening 136. The second lower side rail 132 is pivotably mounted at an upper end 132a to a lower end of the second upper side rail 122 by a pivot connection also provided by a bolt fastening 137. The lower side rails 131, 132 are held apart in a parallel relationship, spaced apart by substantially the same spacing as the upper side rails 121, 122. The lower side rails 131, 132 can pivot around pivot axis x₁ (FIG. 1E), as permitted by bolt fastenings 136, 137.

One or more lower steps 134 (one in the illustrated embodiment) are disposed between the lower side rails 131, 132. The lower step 134 is pivotably connected between lower ends of the lower side rails 131, 132 by bolt fastenings 138. The lower step 134 can pivot around axis x₂ as permitted by bolt fastenings 138.

The upper steps 124a-e and lower step 134 may be substantially identical in dimensions and have a tread depth dimension ‘d’, a step width dimension ‘w’, and a step height dimension ‘h’. The upper steps 124a-e and lower step 134 are flat steps having a major foot engagement surface 135 (FIG. 1D), wherein a tread depth dimension d is greater than the step height dimension h. Pivot axis x₁ intersects midway along the depth of the lowermost upper step 124a and extends parallel to the width dimension w. In the illustrated embodiment, pivot axis x₂ intersects midway along the depth of lower step 134 and extends parallel to the width dimension w.

A connecting link 144 is pivotally connected at an upper end to the upper side rail 121 and at a lower end to the lower step 134. The connecting link 144 is pivotally connected to the lowermost upper step 124a by a bolt fastening 146 which passes through an arcuate slot 145 formed in lower side rail 131. The bolt fastening 146 is secured by a nut, and washers are provided to allow the bolt fastening 146 to slide along the slot 145 and allow the connecting link 144 to pivot with respect to the step 124a. The bolt fastenings 136, 146 together secure the lowermost upper step 124a in position with respect to upper side rail 121.

The connecting link 144 is pivotally connected to the lower step 134 by a bolt fastening 156 which passes through an arcuate slot 155 formed in lower side rail 131. The bolt fastening 156 is secured by a nut, and washers are provided to allow the bolt fastening 156 to slide along the slot 155 and allow the connecting link 144 to pivot with respect to lower step 134.

One or more of the bolt fastenings 136, 137, 138, 146, 156 may, in alternative embodiments, be replaced by alternative suitable joints as known in the art and that allow for pivotal movement between the components concerned. For example, bushing components may be included to help guide the bolts or pins through the arcuate slots.

The lower step 134 is coupled to the upper ladder portion 120 by a four-bar linkage designated generally at 148, wherein the lower side rail 131 and the connecting link 144 serve as a pair of grounded links connecting the lower step 134 (output link) to the upper ladder portion 120 (ground link). The lower ladder portion 130 is thus pivotally connected to the lower end of the upper ladder portion 120 for movement around axis x₁. The orientation of the lower step 134 with respect to the lowermost upper step 124a is maintained by the four-bar linkage when the lower ladder portion 130 is pivoted with respect to the upper ladder portion 120.

It should be understood that the lower ladder portion 130 comprises a further connecting link 164 which, together with the other lower side rail 132, provides another four-bar linkage connecting the opposite side of lower step 134 to the upper ladder portion 120. Further connecting link 164 is largely obscured from view but can be seen in part in FIG. 1D. The further connecting link 164 is connected to the lower step 134 and lowermost upper step 124a in a mirrored fashion to that of connecting link 144.

The lower ladder portion 130 is free to pivot away from an aligned position (FIGS. 1A-D) into a pivoted position, an example of which is shown in FIGS. 1E and 1F. When in the aligned position, the lower step 134 is spaced from the lowermost upper step 124a with the same spacing with which the other upper steps 124 are spaced. Therefore, when in the aligned position, the lower step 134 is positioned to present an ergonomic experience to a user.

The freedom of pivot movement for the lower ladder portion 130 is limited by the dimensions of the arcuate slots 145, 155, the ends of which act as stops for the respective bolt fastenings 146, 156. The lower ladder portion 130 is biased into the aligned position by its own weight. Therefore, unless inhibited by the ground surface 17, the lower ladder portion 130 naturally adopts the aligned position.

In another embodiment, biasing means such as a gas spring or coil spring may be provided to bias the lower ladder portion into the aligned position. In yet another embodiment, an actuator such as a hydraulic or pneumatic cylinder or electric linear actuator, may be provided to actively and/or automatically control the pivot position of the lower ladder portion.

When the lower ladder portion 130 is pivoted away from an aligned position into a pivoted position, the orientation of the lower step 134 is maintained. Advantageously, as best illustrated in FIGS. 1E and 1F, the pitch of lower step 134 is maintained the same as the pitch of the upper steps 124, even when the lower ladder portion is forced to pivot by contacting the ground surface 17. As such, the risk of a user slipping or tripping on an angled step is diminished.

Advantageously, the ladder 100 can be fitted to work vehicles at a height which positions the lowest step 134 close enough to the ground surface 17 to meet the requirements of the aforementioned regulations and to ensure safe and ergonomic use. This is particularly beneficial for work vehicles with adjustable ground clearance. The ladder 100 can be positioned on such a vehicle so as to meet the regulatory requirements at a greater range of chassis positions, relying on the advantage that the lower ladder portion can be lowered to engage the ground surface while maintaining the pitch of the lower step (or steps), as illustrated for example in FIG. 1F.

Although the lower ladder portion 130 of the illustrated embodiment includes only the one step 134, it should be understood that a plurality of lower steps may be provided and coupled to the lower side rails 131, 132 and connecting links 144, 164 in the same way to maintain their pitch when the lower ladder portion is pivoted away from the aligned position.

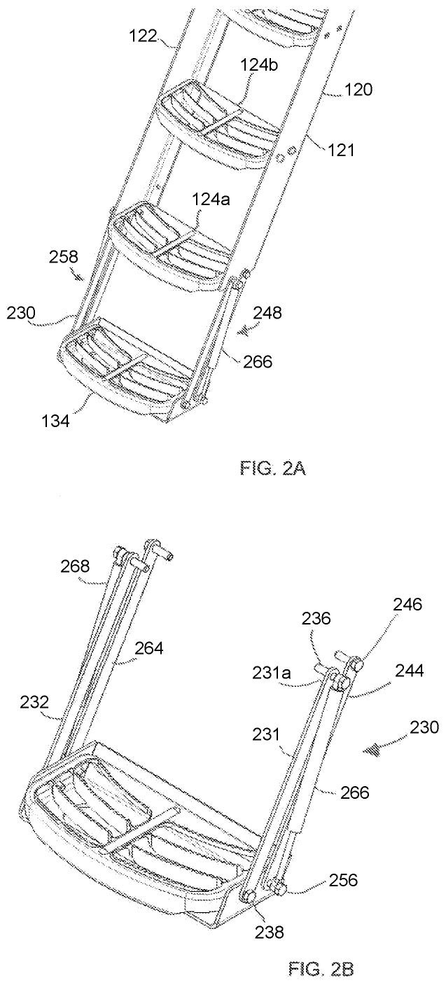

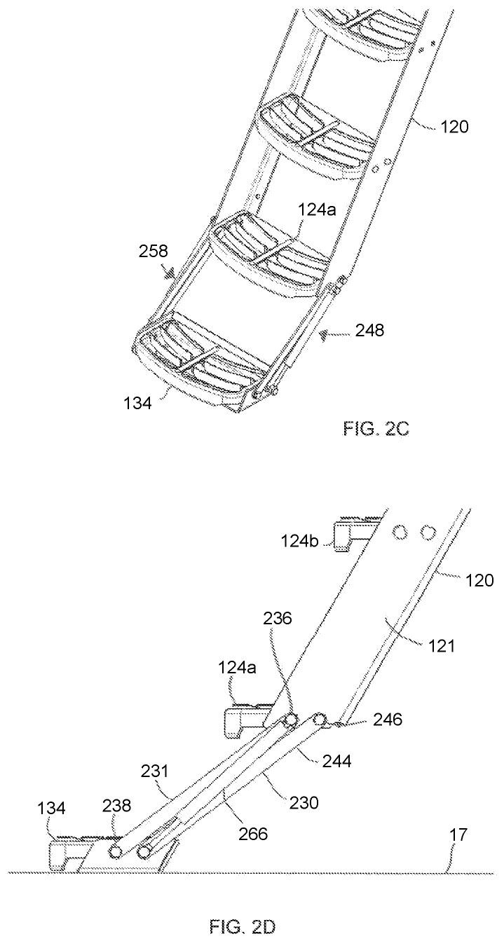

FIGS. 2A-D show another embodiment, in which a ladder 200 has an upper ladder portion 120 having substantially the same construction as that of ladder 100, and a lower ladder portion 230 having a lower step 134. Features sharing the same function and or construction as features of the previous embodiment will adopt the same reference numbers for ease of explanation.

The lower step 134 is coupled to the upper ladder portion 120 by first and second four-bar linkages 248, 258. The first four-bar linkage 248 has first and second connecting links 231, 244. The first connecting link 231 is pivotably mounted at an upper end 231a to a lower end of the first upper side rail 121 by a pivot connection, which is provided in the illustrated embodiment by a bolt fastening 236, and at a lower end to the lower step 134 by a pivot connection, which is provided by bolt fastening 238. The second connecting link 244 is pivotally connected at an upper end to the upper side rail 121 and at a lower end to the lower step 134. The second connecting link 244 is pivotally connected to the lowermost upper step 124a by a bolt fastening 246 or other suitable joint. The bolt fastening 246 is secured by a nut, and washers and/or bushings may be provided to allow the second connecting link 244 to pivot with respect to the step 124a. The bolt fastenings 236, 246 together secure the lowermost upper step 124a in position with respect to upper side rail 121. The second connecting link 244 is pivotally connected to the lower step 134 by a bolt fastening 256. The bolt fastening 256 is secured by a nut, and washers may be provided to allow the second connecting link 244 to pivot with respect to lower step 134.

The first and second connecting links 231, 244 serve as a pair of grounded links connecting the lower step 134 (output link) to the upper ladder portion 120 (ground link).

The second four-bar linkage 258 has third and fourth connecting links 232, 264 connected on the opposite side between the lower step 134 and the lowermost upper step 124a in the same manner as the first and second connecting links 231, 244. The third and fourth connecting links 232, 264 also serve as a pair of grounded links connecting the lower step 134 to the upper ladder portion 120.

The lower step 134 maintains the spacing between the opposite pairs of connecting links, the spacing being substantially the same spacing as the upper side rails 121, 122.

The lower ladder portion 230 is thus pivotally connected to the lower end of the upper ladder portion 120 for movement around an effective axis x₁. The orientation of the lower step 134 with respect to the lowermost upper step 124a is maintained by the four-bar linkage when the lower ladder portion 230 is pivoted with respect to the upper ladder portion 120.

The lower ladder portion 230 is free to pivot away from an aligned position (i.e., as shown in FIGS. 2A and 2B) into a pivoted position, an example of which is shown in FIGS. 2C and 2D. When in the aligned position, the lower step 134 is spaced from the lowermost upper step 124a with the same spacing with which the other upper steps 124 are spaced.

The freedom of pivot movement for the lower ladder portion 230 is limited by a pair of gas springs 266, 268, each being connected between opposite corners of a respective one of the four-bar linkages 248, 258. The first gas spring 266 is pivotally connected at one end to the bolt fastening 236, and at the opposite end to bolt fastening 256. Each gas spring 266, 268 has a range of travel correlated to the range of pivot movement of the lower ladder portion 230.

The gas springs 266, 268 also serve as biasing means to bias the lower ladder portion 230 into the aligned position. In alternative embodiments, the gas springs 266, 268 are replaced with one or more mechanical springs, limiting straps/bars, hydraulic cylinders, electronic actuators, and/or pneumatic actuators.

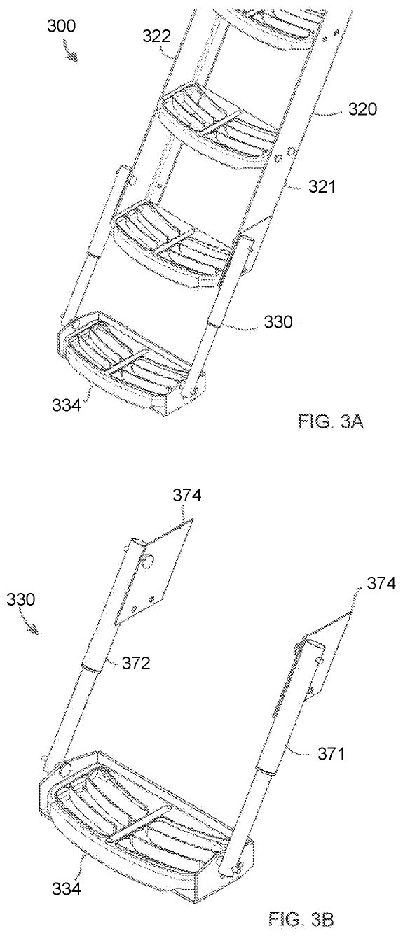

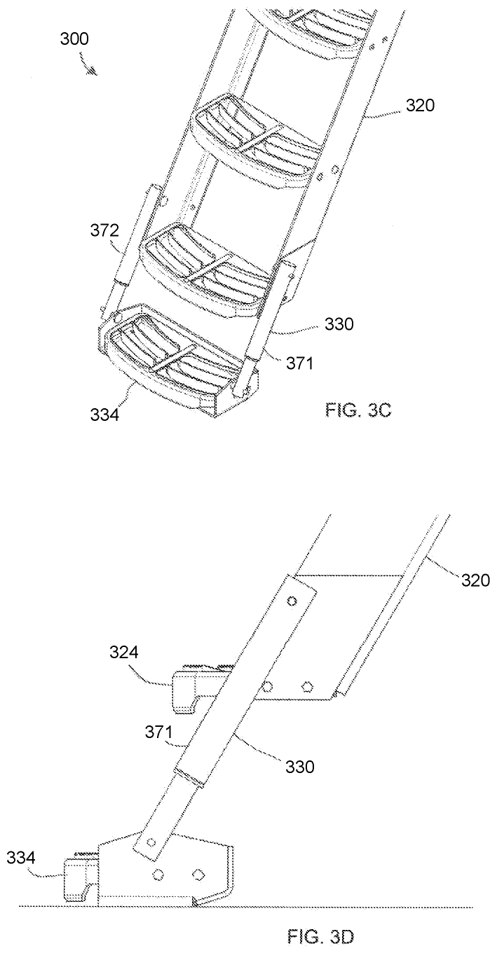

FIGS. 3A-D show another example of an access ladder 300 having a lower ladder portion 330 that moves with respect to an upper ladder portion 320. In this example, the lower ladder portion 330 has a lower step 334 and a pair of telescopic gas springs or actuators 371, 372, which translate the lower step 334 in line with the rise of the ladder between an extended position and a retracted position. The gas springs 371, 372 may be secured to upper side rails 321, 322 of the upper ladder portion 320 by mounting plates 374 and suitable fastening means.

By translating the lower step 324, the orientation (or pitch) thereof is unaffected when the lower ladder portion engages the ground surface 17 (FIG. 3D).

The gas springs 371, 372 also serve as biasing means to bias the lower step 334 into an extended position as shown in FIGS. 3A and 3B.

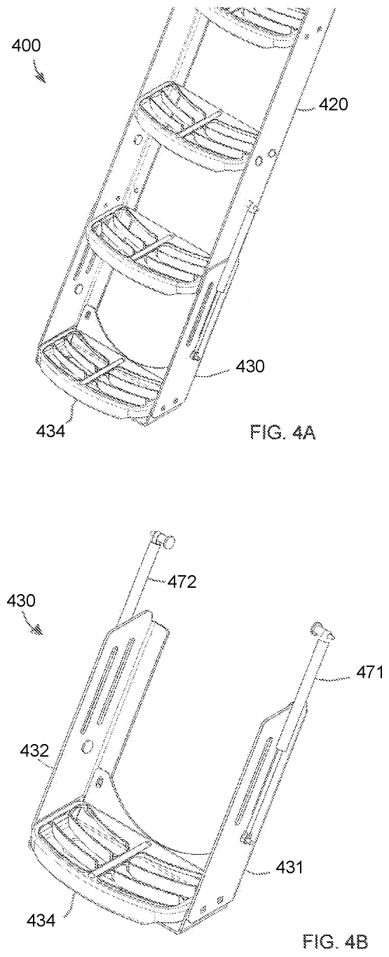

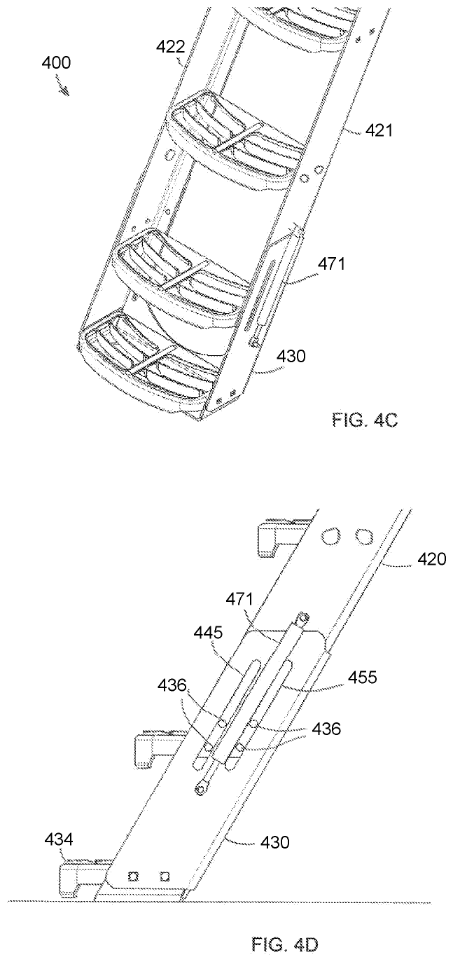

FIGS. 4A-D show another example of an access ladder 400 having a lower ladder portion 430 that moves with respect to an upper ladder portion 420. In this example, like with the previous example, the lower ladder portion 430 has a lower step 434 that translates in line with the rise of the ladder between an extended position and a retracted position. However, in this example, the lower ladder portion 430 has a pair of lower side rails 431, 432 between which the lower step 434 is fixed in position relative thereto.

The lower side rails 431, 432 are slidably mounted to lower ends of upper side rails 421, 422 of the upper ladder portion 420. With reference to FIG. 4D, pins or bolts 436 secured to the upper side rails 421, 422 engage a pair of elongate slots 445, 455 formed in the lower side rails 431, 432. The length of the slots 445,455 determines the range of translation travel that the lower ladder portion 430 can make with respect to the upper ladder portion 420.

The lower ladder portion 430 may have a pair of gas springs 471, 472, each connected outboard of and between a respective one of the upper side rails 421, 422 and a respective one of the lower side rails 431, 432. The gas springs 471, 472 serve to bias the lower ladder portion 430 from a retracted position (FIGS. 4C and 4D) towards an extended position (FIGS. 4A and 4B).

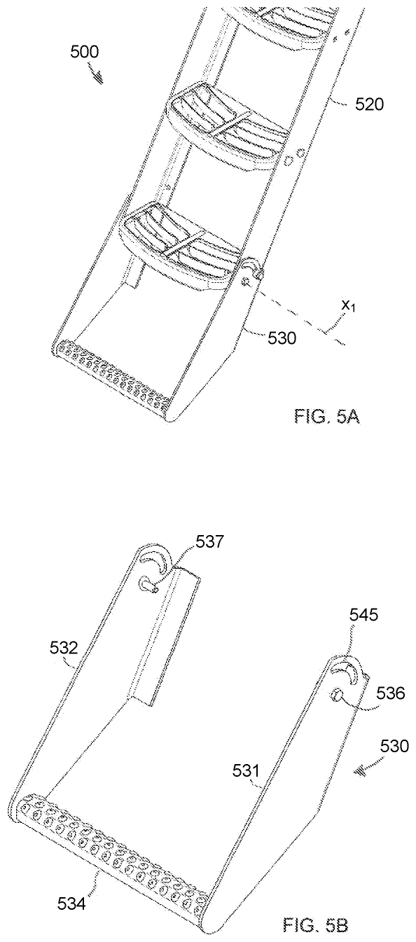

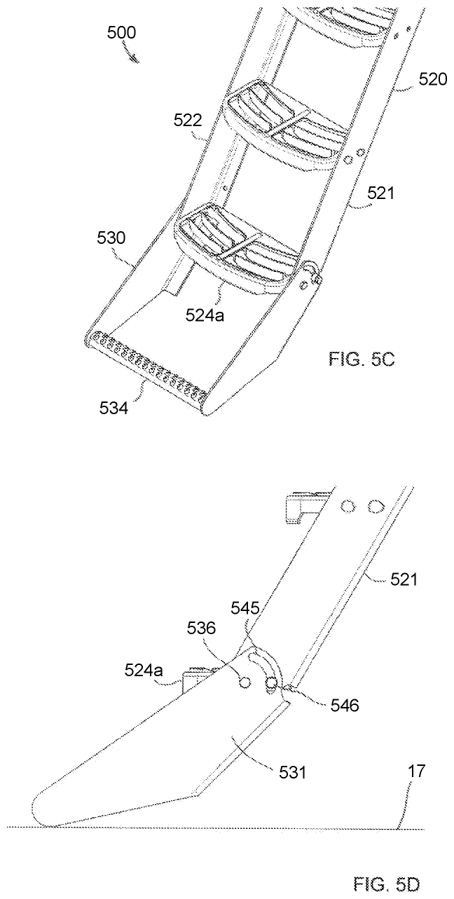

FIGS. 5A-D show yet another example of an access ladder 500 having a lower ladder portion 530 that moves with respect to an upper ladder portion 520. The lower ladder portion 530 has first and second lower side rails 531, 532 which may be formed of steel or aluminum plate, for example. The first lower side rail 531 is pivotably mounted to a lower end of the first upper side rail 521 by a pivot connection, which is provided in the illustrated embodiment by a bolt fastening 536. The second lower side rail 532 is pivotably mounted to a lower end of the second upper side rail 522 by a pivot connection, also provided by a bolt fastening 537. The lower side rails 531, 532 are held apart in a parallel relationship, spaced apart by substantially the same spacing as the upper side rails 521, 522. The lower side rails 531, 532 can pivot around pivot axis x₁ as permitted by bolt fastenings 536, 537.

One or more lower steps 534 (one in the illustrated embodiment) are fixed between the lower side rails 531, 532. In this example, the lower step 534 is a rounded square extrusion formed with a tread pattern that is rounded on the top surface.

Pins or bolts 546 secured to the upper side rails 521, 522 engage a pair of arcuate slots 545 formed in the lower side rails 531, 532. The length of the slots 545 determines the range of pivot travel that the lower ladder portion 530 can make with respect to the upper ladder portion 520.

In this example, it will be appreciated that the pitch of the lower step 536 changes as the lower ladder portion 530 pivots with respect to the upper ladder portion 520. However, due to the rounded square profile of the lower step 534, any change in orientation or pitch does not result in a significant change in the tactile experience of a user.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

What is claimed is:

1. An access ladder for a work vehicle, the access ladder comprising:
an upper ladder portion configured for attachment to a vehicle chassis and comprising an upper step; and
a lower ladder portion pivotally connected to a lower end of the upper ladder portion for movement around an axis that is parallel to the upper step, the lower ladder portion comprising a lower step having an orientation with respect to the upper step that is maintained when the lower ladder portion is pivoted with respect to the upper ladder portion.

2. The access ladder of claim 1, wherein the lower ladder portion is coupled to the upper ladder portion by a four-bar linkage.

3. The access ladder of claim 2, wherein the four-bar linkage comprises two pairs of grounded links wherein the pairs are each connected to opposite sides of the lower step.

4. The access ladder of claim 2, wherein the lower ladder portion comprises:
a pair of lower side rails between which the lower step is pivotally attached, the lower side rails being pivotally connected to the lower end of the upper ladder portion; and
a connecting link pivotally connected at an upper end to the upper ladder portion and at a lower end to the lower step.

5. The access ladder of claim 4, wherein the connecting link is connected to the upper step through a slot formed in one of the lower side rails.

6. The access ladder of claim 4, wherein the connecting link is connected to the lower step through a slot formed in one of the lower side rails.

7. The access ladder of claim 1, further comprising a spring configured to bias the lower ladder portion into alignment with the upper ladder portion.

8. The access ladder of claim 7, wherein the spring comprises a gas spring connected between the upper ladder portion and the lower ladder portion.

9. The access ladder of claim 1, further comprising an actuator configured to move the lower ladder portion relative to the upper ladder portion.

10. The access ladder of claim 1, wherein the upper step and the lower step each define generally planar foot engagement surfaces, and wherein the upper step and the lower step each exhibit a tread depth dimension that is greater than a step height dimension.

11. An agricultural crop sprayer having wheels supporting a chassis by variable height suspension to provide variable ground clearance, and an access ladder secured to the chassis, wherein the access ladder comprises:
an upper ladder portion attached to a vehicle chassis and comprising an upper step; and
a lower ladder portion pivotally connected to a lower end of the upper ladder portion for movement around an axis that is parallel to the upper step and comprising a lower step having an orientation with respect to the upper steps that is maintained when the lower ladder portion is pivoted with respect to the upper ladder portion, and wherein the lower ladder portion contacts the ground when the variable height suspension is set to a lowest ground clearance.

12. The agricultural crop sprayer of claim 11, wherein the upper ladder portion is hinged to the vehicle chassis and is pivotable between an operating position and a stowed position.

13. The agricultural crop sprayer of claim 11, wherein the lower ladder portion comprises a single lower step.
